(19) United States
(12) Patent Application Publication
(10) Pub. No.: US 2013/0270823 A1
(43) Pub. Date: Oct. 17, 2013

(54) Method for Enhancing Low Voltage Ride Through Capability on a Wind Turbine

(71) Applicant: Brian Hannon, Valencia, CA (US)

(72) Inventor: Brian Hannon, Valencia, CA (US)

(73) Assignee: Clipper Windpower, LLC, Carpinteria, CA (US)

(21) Appl. No.: 13/448,859

(22) Filed: Apr. 17, 2012

(51) Int. Cl. F03D 7/04

(52) U.S. Cl. 290/44

(57) ABSTRACT

A method for providing a normal operation of a wind turbine during unstable voltage events at an electric transmission grid using a ferroresonant transformer is disclosed. The method may include providing at least one auxiliary wind turbine component powered through a ferroresonant transformer. The method may further include providing a substantially constant output voltage to the auxiliary component(s) connected to the ferroresonant transformer in an event of an over voltage spike at the electric transmission grid and providing a substantially constant output voltage for a limited period of time to the auxiliary component(s) in an event of a low voltage at the electric transmission grid. The method may additionally include filtering damaging harmonic frequencies from the electric transmission grid during a normal voltage power supply.

### FIELD OF THE DISCLOSURE

The present disclosure generally relates to wind turbines and, more particularly, relates to enhancing low voltage ride through capabilities of auxiliary components on a wind turbine.

### BACKGROUND OF THE DISCLOSURE

A utility-scale wind turbine typically includes a set of two or three large rotor blades mounted to a hub. The rotor blades and the hub together are referred to as the rotor. The rotor blades aerodynamically interact with the wind and create lift, which is then translated into a driving torque by the rotor. The rotor is attached to and drives a main shaft, which in turn is operatively connected via a drive train to a generator or a set of generators that produce electric power. The main shaft, the drive train and the generator(s) may all be situated within a nacelle.

In addition to the above components, a utility-scale wind turbine typically includes significant amount of auxiliary componentry, such as, one or more control system computers, a yaw drive system to change the yaw direction of the wind turbine, a pitch drive system to change the pitch angles of the rotor blades, a cooling system to cool the generators and other electrical components, a hydraulic power unit to provide hydraulic power to various components such as brakes, and the like. These auxiliary components require electric power to function, which is generally provided from an electric transmission grid connected to the wind turbine.

Such electric transmission grids can often become unstable, for example, experience periods of low voltages. Low voltage on the transmission grid may be caused by a fault, such as, a downed tree on the power lines. During periods of transmission grid instability, normal power supply to the auxiliary components may be hampered. In many parts of the world, wind turbines are now required to ride through low voltage periods on the electric transmission grid, i.e., the wind turbine is required to output some power to the transmission grid during the low voltage condition, and be able to ramp up and produce more power or full power immediately or very soon (a few milliseconds) after the voltage on the transmission grid returns to a more normal range.

One of the issues inherent in providing this low voltage ride through (LVRT) capability in a wind turbine is that the auxiliary components of the wind turbine need to be managed so that they can remain functional throughout the low voltage period as necessary, and be available for normal operation as soon as the voltage returns to normal on the grid. In many instances, this means that the components require a supplemental source of electric power during the low voltage event to replace power from the grid. Conventionally, supplemental power is provided by capacitors, battery banks, or other types of electric back-up devices or hydraulic pressure storage devices like accumulators. Such supplemental power systems can not only be large in size, they can also be very expensive and can add to the overall cost of a wind turbine.

Besides dealing with periods of low voltage on the transmission grid, auxiliary components of wind turbines also require some level of isolation and protection from the transmission grid, specifically from quick over-voltage spikes and damaging harmonic frequencies on the transmission grid. Such voltage spikes and harmonics can cause significant damage to the auxiliary components.

Circuit breakers are often employed to protect components such as motors, power supplies, etc. from excessive damaging currents. However, quick over-voltage spikes in the transmission grid power supply can damage auxiliary components before over-current protection in the circuit breaker kicks in. An alternative to the circuit breakers that is now commonly employed is a regular isolation transformer that isolates some auxiliary components from the transmission grid in the event of an over-voltage spike. Conventionally, this isolation transformer is positioned to regulate power to the pitch control unit. By virtue of positioning the isolation transformer just before the pitch control unit, the isolation transformer can protect the pitch control unit from over-voltage spikes on the transmission grid.

### SUMMARY OF THE DISCLOSURE

In accordance with one aspect of the present disclosure, a method of managing a low voltage power supply event in a wind turbine is disclosed. The method may include providing a wind turbine having a plurality of auxiliary components and powering at least one of the plurality of auxiliary components through a ferroresonant transformer capable of outputting nearly continuous voltage down to at least seventy percent or less of the normal input voltage of the at least one of the plurality of auxiliary components. The method may also include operating the at least one of the plurality of auxiliary components in normal operation during an indefinite period of low input voltage for a range of low input voltages including at least one hundred percent to about seventy percent of the normal input voltage of the at least one of the plurality of auxiliary components and operating the at least one of the plurality of auxiliary components in a low voltage ride through state for a definite period of time during a period of low input voltage for a range of voltages including at most zero to about seventy percent of the normal input voltage of the at least one of the plurality of auxiliary components.

In accordance with another aspect of the present disclosure, a method of providing a low voltage ride through capability using a ferroresonant transformer in a wind turbine is disclosed. The method may include providing a wind turbine having a plurality of auxiliary components and providing a ferroresonant transformer connected to at least one of the plurality of auxiliary components on an output side thereof, the ferroresonant transformer capable of providing a substantially constant output voltage supply for varying values of input voltages. The method may also include continuing normal operation of the at least one of the plurality of auxiliary components through the ferroresonant transformer for about five to ten seconds of entering a low voltage ride through state and facilitating shut down of the at least one of the plurality of auxiliary components gradually if the low voltage ride through state persists beyond about five to ten seconds.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is an exemplary single line power distribution diagram for supplying power from an electric transmission grid to a plurality of components within the wind turbine of FIG. 1, in accordance with at least some embodiments of the present disclosure;

FIG. 3 is an exemplary circuit diagram of a ferroresonant transformer for use within the power distribution line diagram of FIG. 2; and

FIG. 4 is a plot showing an exemplary low voltage ride through functionality of a pitch control unit of the wind turbine of FIG. 1 employing the power distribution scheme of FIG. 2.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

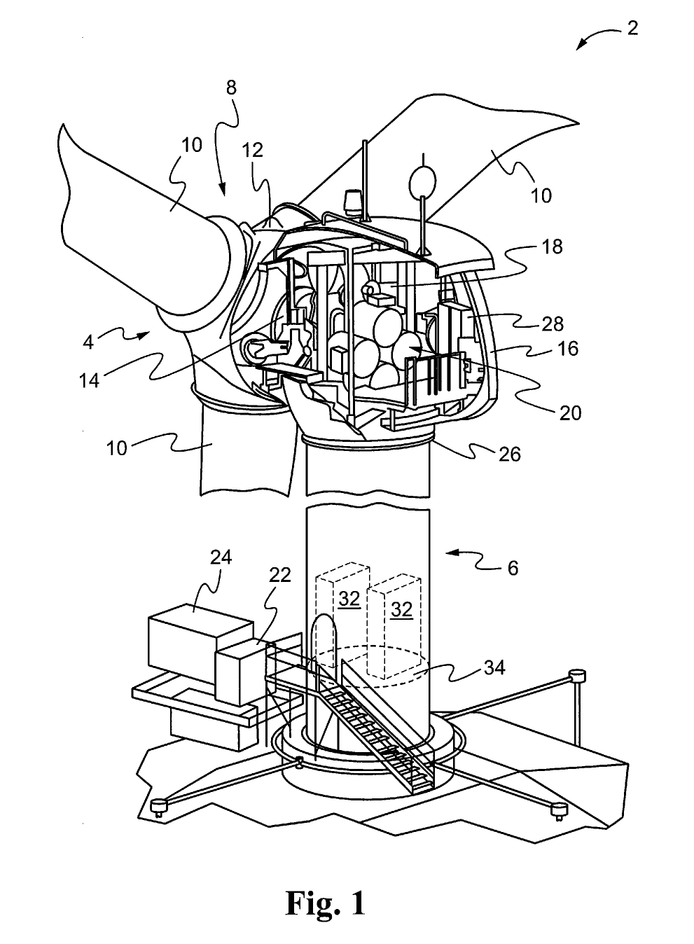

Referring to FIG. 1, an exemplary wind turbine 2 is shown, in accordance with at least some embodiments of the present disclosure. While all the components of the wind turbine have not been shown and/or described, a typical wind turbine may include an up tower section 4 and a down tower section 6. The up tower section 4 may include a rotor 8, which in turn may include a plurality of blades 10 connected to a hub 12. The blades 10 may rotate with wind energy and the rotor 8 may transfer that energy to a main shaft 14 situated within a nacelle 16. The nacelle 16 may additionally include a drive train 18, which may connect the main shaft 14 on one end to one or more generators 20 on the other end. The generators 20 may generate power, which may be transmitted from the up tower section 4 through the down tower section 6 to a power distribution panel (PDP) 22 and a pad mount transformer (PMT) 24 for transmission to an electric transmission grid (not shown). The PDP 22 and the PMT 24, which are typically positioned outside (e.g., in the vicinity) of the wind turbine 2, may also provide electrical power from the grid to the wind turbine for powering several components thereof, as will be described further below.

In addition to the components of the wind turbine 2 described above, the up tower section 4 of the wind turbine may include several auxiliary components, such as a yaw system 26 on which the nacelle 16 may be positioned to pivot and orient the wind turbine in a direction of the wind, a pitch control system (not visible) situated within the hub 12 for controlling the pitch (i.e., the angle of attack of the blades with respect to the passing air) of the blades 10, a hydraulic power system (not visible) to provide hydraulic power to various components such as brakes of the wind turbine, a cooling system (also not visible), and the like. As will be appreciated by those of ordinary skill in this art, the wind turbine 2 may include other auxiliary components such as various sensors and computers, like a turbine control unit (TCU) 28 for controlling the various components of the wind turbine 2.

With respect to the down tower section 6 of the wind turbine 2, among other components the down tower section may include one or more generator control units (GCUs) 32 and a down tower junction box (DJB) 34 for routing and distributing power to various places in the wind turbine.

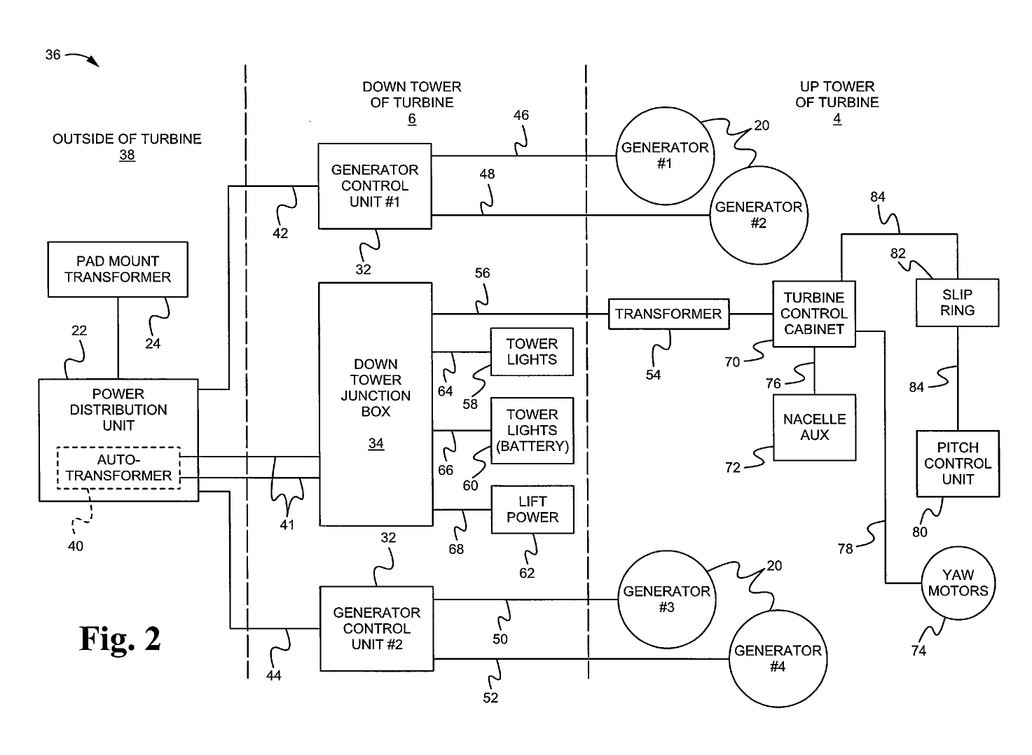

Referring now to FIG. 2, an exemplary single line diagram 36 illustrating power distribution from the electric transmission grid to various components within the wind turbine 2 is shown, in accordance with at least some embodiments of the present disclosure. For simplicity of explanation, the single line diagram 36 is divided into three sections, namely, an outside of turbine section 38, the down tower section 6 and the up tower section 4. As shown, power to the various components of the down tower section 6 and the up tower section 4 may be provided from the grid via the PDP 22 and the PMT 24, both of which are shown positioned in the outside of turbine section 38 (although this need not always be the case). Specifically, the PMT 24 may receive an alternating current (AC) power supply from the grid, which may be transferred to the PDP 22 for regulation and distribution to the wind turbine 2. In at least some embodiments, the PMT 24 may provide six hundred ninety volts three phase alternating current power (690 VAC) from the grid to the PDP 22, which may then regulate and distribute the AC power supply via a transformer 40 to the DJB 34 situated within the down tower section 6 of the wind turbine 2, as shown by exemplary power lines 41. The PDP 22 may also provide AC power to various other components of the wind turbine 2, which may then convert the AC power into a direct current (DC) power supply locally by way of one or more power supply units. Notwithstanding the fact that in the present embodiment, the PMT 24 has been described as providing 690 VAC three phase power to the PDP 22, it will be understood that this number is merely exemplary and may vary in other embodiments, depending particularly upon the requirements and sizes of the wind turbine 2 and the various components thereof.

The DJB 34 upon receiving the AC power supply from the transformer 40 may distribute the AC power to a ferroresonant transformer 54 situated within the up tower section 4 via power line 56. The ferroresonant transformer 54 is described in greater detail below. In addition to distributing power to the ferroresonant transformer 54, the DJB 34 may also provide the AC power supply to several other components located in the down tower section 6, such as, one or more tower lights 58, backup battery 60 for the tower light(s) and a lift power 62 via power lines 64, 66 and 68, respectively. It will be understood that although only the components 54 and 58-62 have been shown as receiving power supply from the DJB 34, in at least some embodiments other components in the up tower section 4 and the down tower section 6 that may require AC electrical energy (including back-up power) to operate may receive power from the DJB. Furthermore, it will be understood that the power supply provided and circulated from the PMT 24, the PDP 22 and the DJB 34 may either be a single phase power supply or it may be a two or three phase power supply, depending upon the power requirements of the components to which the power is supplied to.

In addition, the GCUs 32 may receive DC power supply from the generators 20 situated within the up tower section 4, as shown by power lines 46, 48, 50 and 52, and convert the DC power supply into an AC power supply and transmit it to the PDP 22, along power lines 42 and 44.

Referring still to FIG. 2, the ferroresonant transformer 54 may receive input power (e.g., three phase AC power) from the DJB 34 and may regulate and output that power supply to a turbine control cabinet (TCC) 70. The TCU 28 and various other auxiliary component controls may be included inside the TCC 70. As mentioned above, the TCU 28 may be responsible for controlling several components within the wind turbine 2 and power to operate those components may be supplied from within the TCC 70. For example, and as shown, the TCC 70 may provide a power supply to certain auxiliary components 72 found in the nacelle 16 and to yaw motors 74 of the yaw system 26 via power lines 76 and 78, respectively. The TCC 70 may also distribute power to a pitch control unit 80 through a slip ring 82 via a power line 84. Although the TCC 70 is shown as supplying power only to the auxiliary components 72, the yaw motors 74 and the pitch control unit 80, in at least some other embodiments, several other components that require a constant power supply for a proper and continuous operation of the wind turbine 2 may receive a power supply from the TCC through the ferroresonant transformer 54.

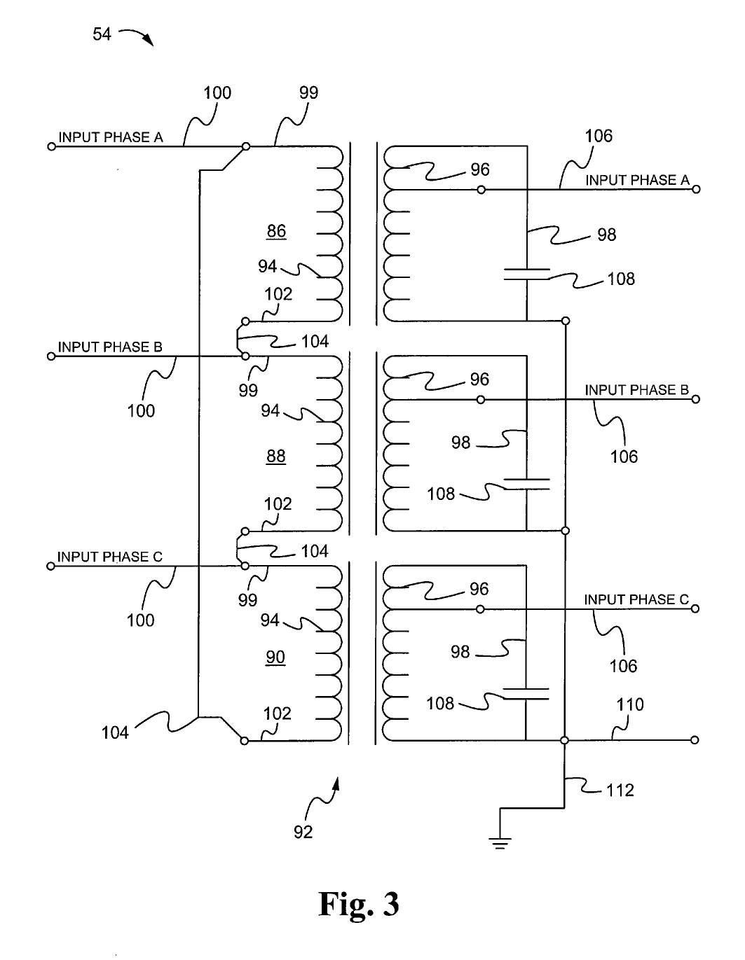

Turning now to FIG. 3, an exemplary wiring diagram schematic of the ferroresonant transformer 54 is shown, in accordance with at least some embodiments of the present disclosure. Specifically, the ferroresonant transformer 54 may be employed to (a) isolate the power supply of the auxiliary components (such as the auxiliary components 72, the yaw motors 74 and the pitch control unit 80) of the wind turbine 2 from the electric transmission grid during periods of quick over voltage spikes; (b) provide low voltage ride through (LVRT) capability by outputting a constant voltage given varying input voltages, thereby enhancing the low voltage ride through capability of the auxiliary components of the wind turbine; and (c) provide protection from damaging harmonic frequencies of the electric transmission grid during normal voltage operation.

An exemplary ferroresonant transformer that may be employed for purposes of the present disclosure may include first, second and third independent ferroresonant transformers 86, 88 and 90, respectively, which may be connected together to form a three (3) phase ferroresonant transformer 92. Each of the independent ferroresonant transformers 86-90 may include a primary side having a primary coil 94 and a secondary side having a secondary coil 96 and a tank circuit 98 connected in parallel with the secondary coil. The primary and the secondary coils 94 and 96, respectively, may be wrapped around an iron core. On the primary side, a first end 99 of each of the primary coils 94 may be connected to an input voltage 100, while a second end 102 of the primary coils may be connected to the first end of the next ferroresonant transformer via a tap wire 104 for forming the three (3) phase ferroresonant transformer 92. Specifically, the second end 102 of the first ferroresonant transformer 86 may be connected to the first end 99 of the second ferroresonant transformer 88, the second end of the second ferroresonant transformer may be connected to the first end of the third ferroresonant transformer 90 and the second end of the third ferroresonant transformer may be connected to the first end of the first ferroresonant transformer. In the present embodiment, three of the ferroresonant transformers 86-90 have been connected to form the ferroresonant transformer 92. In at least some other embodiments, the number of the ferroresonant transformers connected together may vary, depending upon the input and the output power requirements.

On the secondary side, each of the secondary coils 96 may regulate the input voltage 100 received on its respective primary side and output the regulated voltage along output power line 106. Regulation of the input voltage 100 by a ferroresonant transformer is commonly known and accordingly, will not be described here in full detail. Generally speaking, the ferroresonant transformer 92 uses the principle of ferroresonance, i.e., operation in the region of magnetic saturation, to produce a nearly constant output voltage given varying input voltages. In accordance with the principle of ferroresonance, when the iron core of the ferroresonant transformer is in saturation, relatively large changes in voltage on the input side (e.g., the primary side) produce very small changes in voltage on the output side (e.g., the secondary side). The ferroresonant transformer 92 is designed so that it normally operates in a state of magnetic saturation in its iron cores, thereby providing voltage regulation and a smooth, generally constant output voltage over a wide range of input voltages and operating ranges.

With respect to the tank circuit 98 (also commonly referred to as a resonant circuit), it may include a bank of capacitors 108 that may be employed as a filter for effectively filtering out any harmonics created by saturation of the iron core. The tank circuit 98 may further provide a mechanism for storing energy in the form of AC oscillations, which may be utilized for sustaining output winding voltage (e.g., the regulated output voltage along the output power line 106) for brief periods of loss of the input voltage 100 (e.g., for a few milliseconds). In addition to blocking harmonics created by the saturated core, the tank circuit 98 may also filter out harmonic frequencies generated by nonlinear (switching) loads in the secondary coils 96 and any harmonics present in the input voltage 100.

Furthermore, each of the secondary coils 96 and the tank circuits 98 may be connected to an AC power neutral line 110 and a ground wire 112 to provide an isolated WYE connection output. Thus, in at least some embodiments and as shown, the ferroresonant transformer 92 may take a three phase Delta connection on the input or the primary side and provide a regulated three phase isolated Wye connection on the output or the secondary side. Notwithstanding the configuration of the ferroresonant transformer 92 described above, it will be understood that the above configuration may vary depending upon the requirements of the auxiliary components of the wind turbine 2. In general, ferroresonant transformers may be built to accept a wide range of voltages and output a consistent, generally constant voltage.

By virtue of regulating the input voltage 100 and by utilizing the tank circuit 108, the ferroresonant transformer 92 provides several advantages. For example, the ferroresonant transformer 92 provides (a) a constant output voltage given substantial variations in input voltage, (b) harmonic filtering between the input and the output sides; and (c) the ability to ride through brief losses in grid voltage by keeping a reserve of energy in its resonant tank circuit. Furthermore, the ferroresonant transformer 92 is also highly tolerant of excessive loading and transient (momentary) voltage surges (e.g., over-voltage spikes).

Returning to FIG. 2, the capabilities of the ferroresonant transformer 92 to maintain a nearly constant output voltage throughout a range of input voltages may be utilized to not only isolate and protect the auxiliary components (the auxiliary components 72, the yaw motors 74 and the pitch control unit 80) connected on the output side of the ferroresonant transformer from quick over-voltage spikes and damaging harmonic frequencies at the electric transmission grid (which is at least indirectly connected on the input side of the ferroresonant transformer), but may also be used to provide a constant voltage in the event of low voltage periods at the transmission grid. By virtue of providing a regulated normal voltage supply to the auxiliary components connected to the ferroresonant transformer 92, the ferroresonant transformer may provide a low voltage ride through (LVRT) capability to those components, which can continue normal operation in the event of low voltages at the grid.

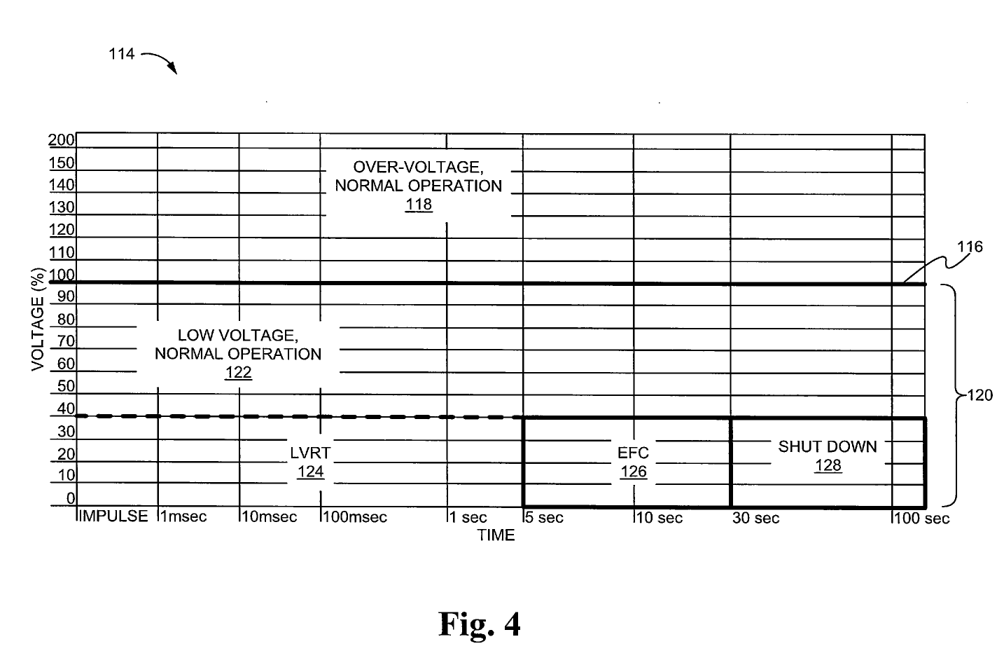

Referring now to FIG. 4, an exemplary plot 114 illustrating the over voltage and LVRT tolerances for the pitch control unit 80 using the ferroresonant transformer 92 is shown, in accordance with at least some embodiments of the present disclosure. It will be understood that although the plot 114 has been explained with reference to the pitch control unit 80, similar inferences for other auxiliary components of the wind turbine 2, such as the yaw motors 74, may be drawn. As shown, the plot 114 plots voltage as a percentage of nominal (or normal) voltage value along the Y-axis against a logarithmic scale of time along the X-axis. A voltage value of one hundred percent (100%) of the nominal voltage along the Y-axis illustrates a normal operating voltage for the pitch control unit 80. Thus, any value above one hundred percent (100%) value represents an over-voltage condition, while any value below one hundred percent (100%) represents a low voltage condition. For clarity of expression, the over-voltage zone is shown separated from the low voltage zone by a line 116.

With respect to over-voltage spike conditions, the pitch control unit 80 must be able to protect itself from voltage surges over its normal operating voltage range and must be able to survive with no damage thereto. An exemplary requirement of the pitch control unit 80 may state that the pitch control unit be able to operate normally and survive voltage surges of one hundred ten percent of nominal value (110%) continuously, a one hundred fifteen percent of nominal voltage spike (115%) for up to seven seconds (7 sec), a one hundred twenty percent (120%) voltage surge up to five seconds (5 seconds), a one hundred thirty (130%) voltage surge up to five hundred milliseconds (500 msec), and so on.

With the use of the ferroresonant transformer 92, the above mentioned requirements are easily met. Specifically, the ferroresonant transformer 92 will not pass any voltages higher than what it is tuned to pass. For example, if the ferroresonant transformer 92 is tuned to pass four hundred volts (400V) and a voltage of five hundred volts (500V) is provided (e.g., due to voltage spike) as the input voltage 100 on the input side of the ferroresonant transformer, the ferroresonant transformer will still only output the four hundred volts (400V) that it is tuned for, thereby providing protection against over-voltage spikes. Accordingly, the pitch control unit 80 will continue to operate normally during those over-voltage spikes due to the voltage regulation provided by the ferroresonant transformer 92. The normal operation of the pitch control unit 80 during over voltage spikes is shown in the plot 114 by region 118 lying above the line 116. The pitch control unit 80 may continue to operate normally irrespective of the amount of the over voltage spike, up to as much as 200% of the nominal voltage.

Relatedly, with respect to low voltage conditions, as described above, any voltage dips below one hundred percent (100%) of the nominal voltage value represents a low voltage condition. The low voltage condition may be shown in the plot 114 by region 120. As the voltage drops from one hundred percent (100%) to about forty percent (40%) of the nominal value, the pitch control unit 80 may continue to operate normally given that the power to the pitch control unit is regulated by the ferroresonant transformer 92. For example, if the input voltage to the ferroresonant transformer drops to 300V, if the ferroresonant transformer is designed to output a voltage of 400V it will continue to have an output at or very near to 400V in spite of the drop of input voltage. This normal operation of the pitch control unit 80 is illustrated by region 122 in the plot 114. As the input voltage to the ferroresonant transformer 92 drops further to below forty percent (40%) of the nominal voltage, the pitch control unit 80 may enter a low voltage ride through (LVRT) state. Entering the LVRT state below forty percent (40%) is in contrast to conventional systems in which the pitch control unit 80 enters an LVRT state when the voltage merely falls below ninety percent (90%) of the nominal value. Thus, with the use of the ferroresonant transformer 92, the current disclosure provides a mechanism in which the pitch control unit 80 may continue to operate normally using power from the transmission grid in a much wider range of conditions compared to conventional systems and without using any power from its backup battery/capacitor system.

In the LVRT state when the input voltage to the ferroresonant transformer 92 falls below the forty percent (40%) range, the pitch control unit 80 may still continue to operate normally, but instead of obtaining power from the transmission grid, the pitch control unit may at some point automatically switch to its back-up power. This LVRT state of back-up power operation of the pitch control unit 80 is shown in the plot by region 124. In this LVRT state, the pitch control unit 80 is capable of continuing normal function for at least five to ten seconds, although the function of pitch control unit 80 may include taking certain protective steps during this low voltage period in case the regular grid voltage does not soon return. During the LVRT period, the pitch control unit 80 is capable of receiving and responding to commands from the turbine control unit (TCU) 28.

After about five to ten seconds of operating in LVRT, if the grid voltage does not return to above at least about 40%, the pitch control unit 80 (and/or the TCU 28) may initiate a fault and the wind turbine 2 may enter an emergency feather condition (EFC), shown by region 126 in the plot 114. During the EFC, the pitch control unit 80 will conduct an emergency shut down. The EFC shut down may require 20 to 30 seconds to complete. After the EFC, the wind turbine 2 is in a shut down state indicated by region 128 in diagram 114 for the remainder of the low voltage event, until the grid voltage is restored and the turbine can be restarted.

It will be understood again that although the plot 114 has been described in relation to the pitch control unit 80, similar functionality can be achieved for other auxiliary components of the wind turbine 2 that are powered through the ferroresonant transformer 92.

Thus, the present disclosure sets forth a mechanism for using a ferroresonant transformer in a wind turbine as a power supply for important up-tower auxiliary components. The ferroresonant transformer may isolate these components very effectively from a wide range of over voltage spikes at the transmission grid. The ferroresonant transformer may also help these components ride through periods of low voltage and continue to function normally by providing a nearly constant output frequency and voltage throughout a wide range of input voltages. Furthermore, the ferroresonant transformer provides a relatively inexpensive mechanism for handling a variety of low voltage, over voltage and damaging harmonic conditions from the transmission grid.

While only certain embodiments have been set forth, alternatives and modifications will be apparent from the above description to those skilled in the art. These and other alternatives are considered equivalents and within the spirit and scope of this disclosure and the appended claims.

We claim:

1. A method of managing a low voltage power supply event in a wind turbine, the method comprising:
providing a wind turbine having a plurality of auxiliary components;
powering at least one of the plurality of auxiliary components through a ferroresonant transformer capable of outputting nearly continuous voltage down to at least seventy percent or less of the normal input voltage of the at least one of the plurality of auxiliary components;
operating the at least one of the plurality of auxiliary components in normal operation during an indefinite period of low input voltage for a range of low input voltages including at least one hundred percent to about seventy percent of the normal input voltage of the at least one of the plurality of auxiliary components; and
operating the at least one of the plurality of auxiliary components in a low voltage ride through state for a definite period of time during a period of low input voltage for a range of voltages including at most zero to about seventy percent of the normal input voltage of the at least one of the plurality of auxiliary components.

2. The method of claim 1, wherein continuing in normal operation comprises allowing the ferroresonant transformer to provide a substantially constant voltage supply of about one hundred percent of the normal input voltage of the at least one of the plurality of auxiliary components.

3. The method of claim 1, wherein during the low voltage ride through state the ferroresonant transformer is not capable of outputting power at substantially near one hundred percent of the normal input voltage of the at least one of the plurality of auxiliary components due to the low input voltage, and the at least one auxiliary component begins to draw power from a back-up power supply.

4. The method of claim 1, wherein entering the low voltage ride through state further comprises entering the wind turbine in an emergency feather condition if the low voltage ride through state persists for more than about five to ten seconds.

5. The method of claim 1, wherein the ferroresonant transformer is connected at least indirectly to an electric transmission grid on an input side thereof and connected at least indirectly to the at least one of the plurality of the auxiliary components of the wind turbine on an output side thereof.

6. The method of claim 5, wherein the auxiliary components comprise a pitch control unit.

7. A method of providing a low voltage ride through capability using a ferroresonant transformer in a wind turbine, the method comprising:
providing a wind turbine having a plurality of auxiliary components;
providing a ferroresonant transformer connected to at least one of the plurality of auxiliary components on an output side thereof, the ferroresonant transformer capable of providing a substantially constant output voltage supply given varying values of input voltages;
continuing operation of the at least one of the plurality of auxiliary components for about five to ten seconds of entering a low voltage ride through state; and
facilitating shut down of the at least one of the plurality of auxiliary components gradually if the low voltage ride through state persists beyond about five to ten seconds.

8. The method of claim 7, wherein continuing operation includes switching to back-up power after entering the low voltage ride through state.

9. The method of claim 7, wherein the at least one of the plurality of auxiliary components continue normal operation by utilizing power from a transmission grid before entering the low voltage ride through state.

10. The method of claim 7, wherein the ferroresonant transformer receives a three phase delta power supply as input and provides a three phase isolated wye power supply to the at least one of the plurality of auxiliary components.
